(19) United States
(12) Patent Application Publication
(10) Pub. No.: US 2008/0060449 A1
(43) Pub. Date: Mar. 13, 2008

(54) PRESSURE DROP FLOW METER HAVING INTERCHANGEABLE, METAL-TO-METAL SEALING METERING ELEMENT

(76) Inventor: Rusty Darsey, Cypress, TX (US)

Correspondence Address: RICHARD A. FAGIN, P.O. BOX 1247, RICHMOND, TX, 77406-1247, US

(21) Appl. No.: 11/780,944

(22) Filed: Jul. 20, 2007

Related U.S. Application Data
(60) Provisional application No. 60/832,357, filed on Jul. 22, 2006.

(51) Int. Cl. G01F 1/46

(52) U.S. Cl. 73/861.65

(57) ABSTRACT

A flow meter includes a first coupling configured to couple to an inlet from a flow stream at one end and to one side of a meter element at another end. A second coupling is configured to couple at one end to an outlet to the flow stream and to the other side of the meter element at another end thereof. The meter element is disposed between the first and second couplings. The meter element is configured to generate a pressure drop in flowing fluid related to a flow rate of the fluid through the meter element. The meter element has metal to metal sealing surfaces for engagement with corresponding sealing surfaces on the respective ends of the first and second couplings.

### CROSS-REFERENCE TO RELATED APPLICATIONS

Priority is claimed from U.S. Provisional Application No. 60/832,357 filed on Jul. 22, 2006.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of flow measuring devices. More specifically, the invention relates to flow meters having various pressure-drop inducing elements disposed in a flow stream.

1. Background Art

Pressure drop flow meters known in the art include a device introduced into the flow stream of a fluid that induces a drop in pressure in the fluid as the flow stream passes through the device. The drop in pressure is measured, and the measured pressure drop is thus related to the volumetric and/or mass flow rate of the fluid through the device. The relationship between pressure drop and flow rate is typically characterized with respect to the type of pressure-drop inducing device and its dimensions, as well as the dimensions of the elements that couple the device to the flow stream.

A common type of pressure drop flow meter known in the art is a so-called “orifice plate” meter, or orifice meter. An orifice meter includes a generally flat plate having a known diameter opening or orifice generally in the center thereof. The orifice plate is coupled to the flow stream between two flanged couplings. Each of the flanged couplings will include a tap or port proximate the orifice plate to expose the fluid pressure extant on each side of the orifice plate to a measuring device, which may be a differential pressure transducer, a pressure transducer for each port, or similar device. Depending on the orifice size and the size of the flanged couplings, the pressure difference between the two ports may be characterized with respect to flow rate of the fluid through the orifice plate.

There are a number of other types of pressure drop flow meter devices known in the art, such as “wedge meters” and flow nozzles. In each case, specialized flanged couplings are generally provided for the type of metering device or element used. Therefore, to have available the various types of flow meters, it is necessary, using elements known in the art, to provide separately configured flanges for each meter type. Typically, metering elements known in the art are sealed to the flanged couplings using separate sealing elements, typically made from elastomer or similar material.

What it needed is a flow meter system that enables using a single configuration for flanged or other flow stream coupling, and eliminates the need for separate sealing elements.

### SUMMARY OF THE INVENTION

One aspect of the invention is a flow meter including a first coupling configured to couple to an inlet from a flow stream at one end and to one side of a meter element at another end. A second coupling is configured to couple at one end to an outlet to the flow stream and to the other side of the meter element at another end thereof. The meter element is disposed between the first and second couplings. The meter element is configured to generate a pressure drop in flowing fluid related to a flow rate of the fluid through the meter element. The meter element has metal to metal sealing surfaces for engagement with corresponding sealing surfaces on the respective ends of the first and second couplings.

Other aspects and advantages of the invention will be apparent from the following description and the appended claims.

### BRIEF DESCRIPTION OF THE DRAWINGS

FIG. 1 shows one embodiment of a flow meter according to the invention.

FIGS. 2 through 4 show additional embodiments of a flow meter according to the invention.

FIG. 5 shows a Pitot-tube type flow meter according to the invention.

### DETAILED DESCRIPTION

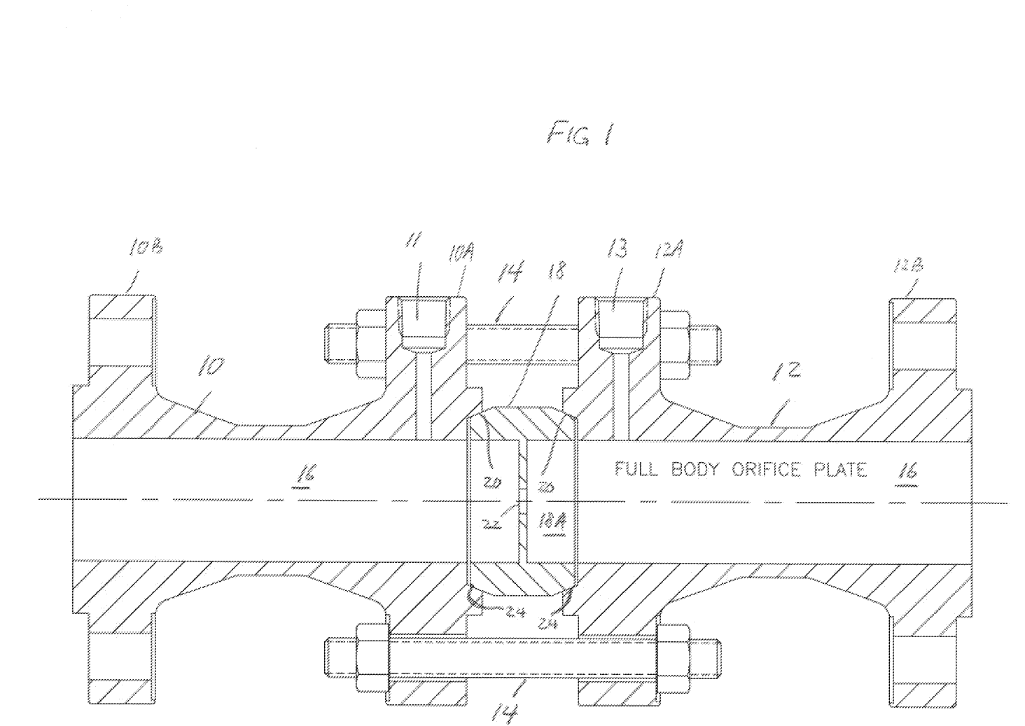

FIG. 1 shows one embodiment of a flow meter according to the invention. The embodiment shown in FIG. 1 is known as an orifice meter, because the metering element is a simple orifice in a flat plate. Characterization of the pressure drop with respect to flow rate of the flow meter shown in FIG. 1 is thus essentially identical to characterization of flow rate for any orifice meter known in the art prior to this invention.

The flow meter may include a first coupling, which in the present embodiment is a flange element 10, and a second coupling, which in the present embodiment may also be a flange element 12. The flange elements are used to couple the flow meter in a flow stream. Coupling to the flow stream may be performed using conventionally formed flanges 10B, 12B on the outer axial ends of each flange element 10, 12 respectively. Inner axial ends of each flange element 10, 12 may include a meter flange 10A, 12A respectively. The meter flanges 10A, 12A may include a generally tapered, metal-to-metal seal sealing surface 24 machined or otherwise formed therein. The sealing surfaces 24 cooperatively engage with corresponding sealing surfaces 20 on the axial ends of a metering element 18. The flange elements are mated and provide compressive force to seal the sealing elements 20, 24 to each other by threaded fasteners 14 of types well known in the art.

The metering element 18 in the present embodiment is an orifice element. The metering element 18 includes a generally full-bore opening 18A on each side of a generally flat metering plate 22 having an orifice generally in the center thereof. The full bore opening 18A is essentially the same diameter as the internal diameter of the bores 16 of the flanged couplings 10, 12. The metering element 18 will induce pressure drop with respect to flow that may be characterized essentially identically to any other orifice plate meter known in the art prior to this invention. Pressure drop may be measured across a port 11, 13 in each flanged coupling 10, 12 at a position proximate the metering element 18. The metering element 18 may include any size orifice in the plate 22 that is ordinarily used with the particular size bore 16 in the flanged couplings.

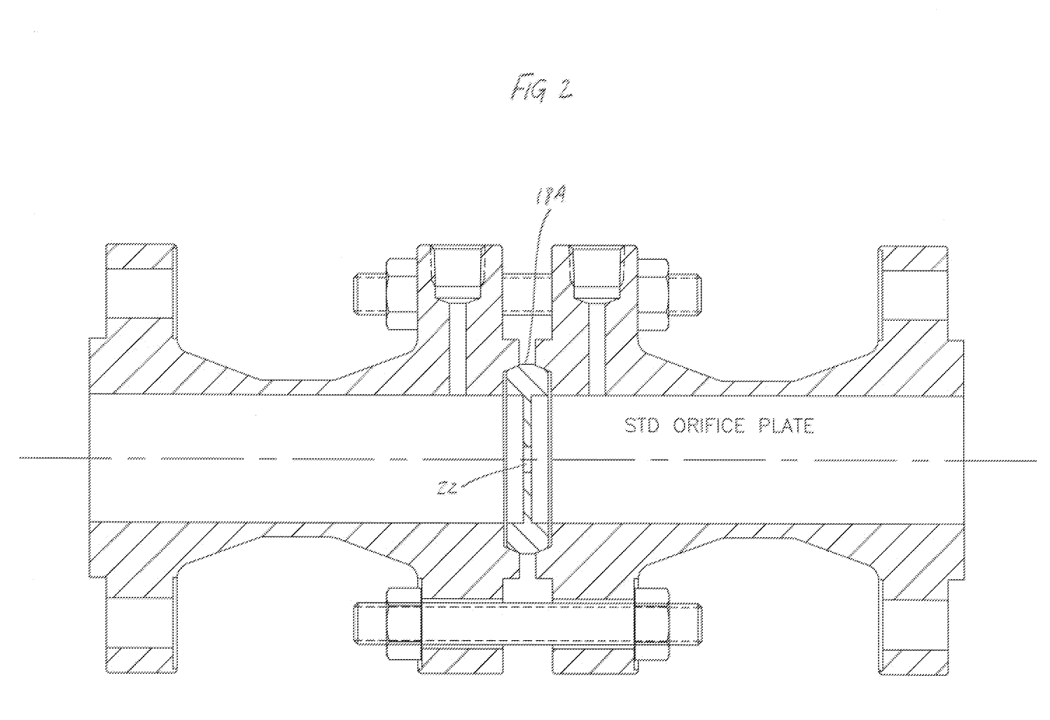

In a flow meter according to the invention, the metering element 18 may be substituted by different types of metering elements, but may use the same flanged couplings. For example, referring to FIG. 2, a “standard” orifice plate 18A may be included between the flanged couplings 10, 12, rather than what is referred to as a “full body” orifice plate as shown in FIG. 1. The principal purpose of the full body orifice plate shown in FIG. 1 is to have each of the various types of metering elements have essentially the same axial dimension (aligned with the bores 16) to simplify selecting sizes for the various components of the flow meter, in particular the threaded fasteners 14.

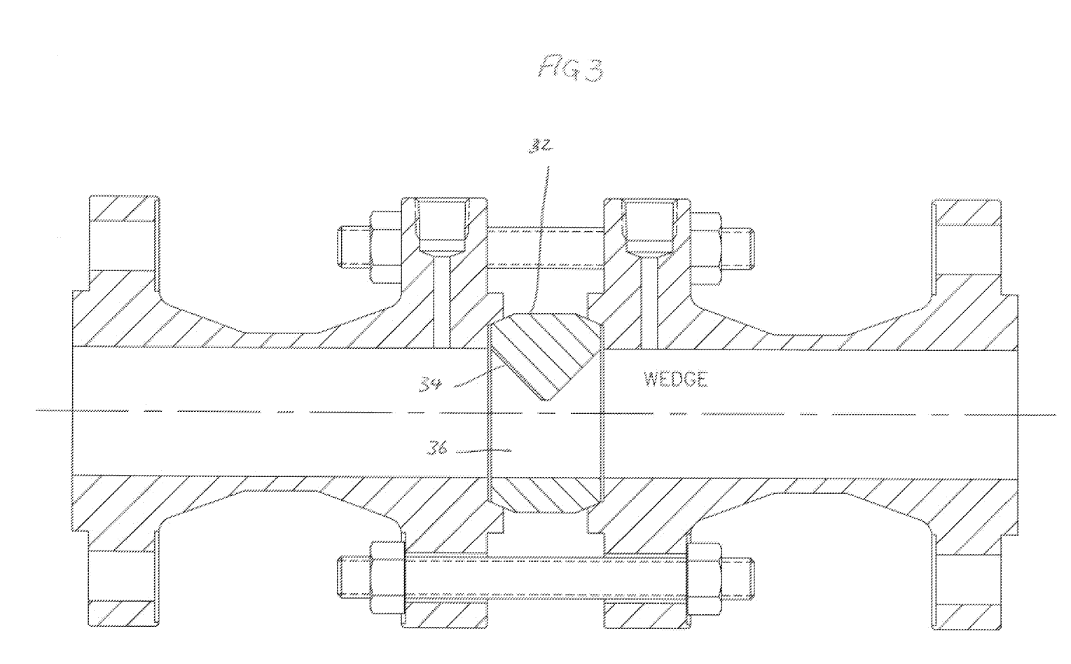

FIG. 3 shows a wedge meter element 32, which includes a general 14 wedge shaped flow diverter 34 and a flow opening 36. Wedge meter elements have high resistance to erosion as contrasted with orifice meter elements, however they are somewhat different in their pressure drop characteristics with respect to flow rate as contrasted with orifice meter elements.

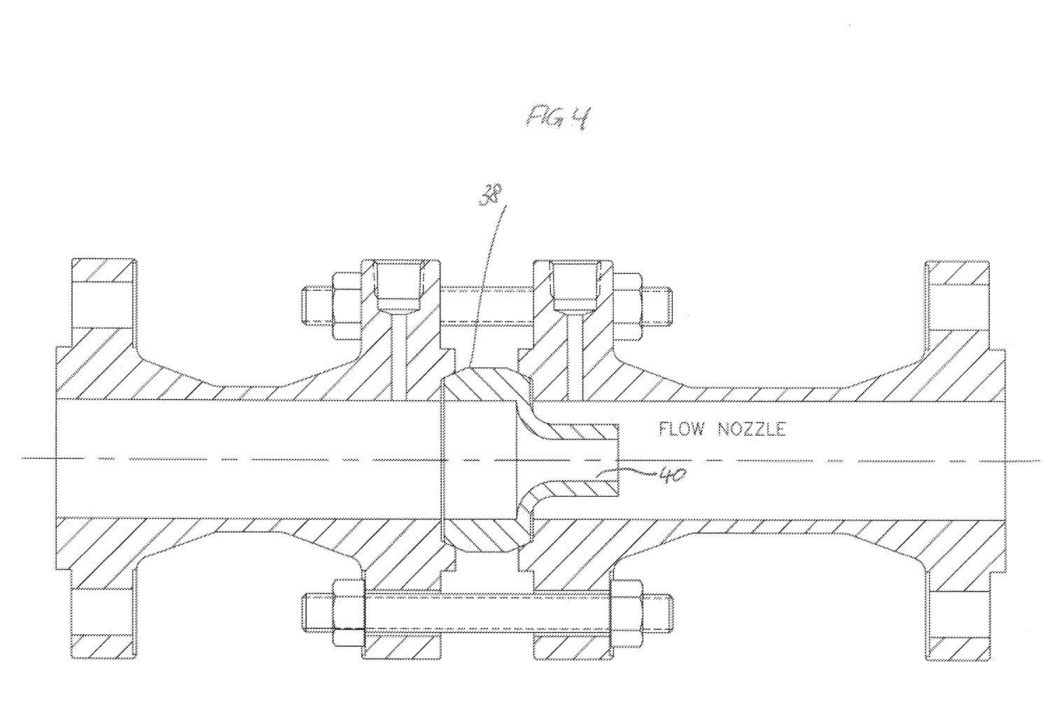

FIG. 4 shows a nozzle-type meter element 38 having a nozzle 40 extending generally in the direction of flow of fluid through the flow meter.

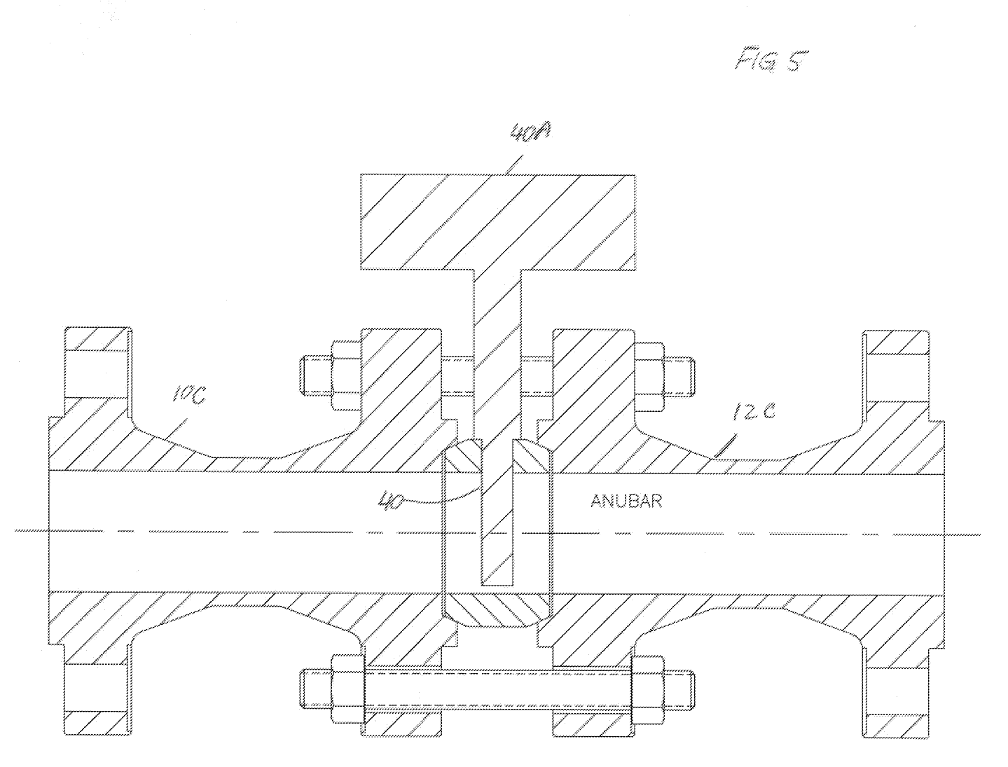

FIG. 5 shows a Pitot-tube type meter element. In the embodiment of FIG. 7, a signal related to pressure drop is generated by fluid flow past the Pitot tube 40. The pressure drop signal may be communicated to any known form of signal transducer, shown schematically at 40A. In the embodiment of FIG. 5, because the pressure drop signal is generated in the Pitot tube, no ports are needed in the flanged couplings 10C, 12C. In one implementation, the flanged couplings shown in FIGS. 1 through 6 including pressure ports therein may be used with a Pitot tube meter element, and such ports may be plugged. Thus manufacturing and inventory may be simplified and associated costs reduced.

It should also be clearly understood that using flanged couplings is only one possible type of coupling between the various embodiments of meter element and the flow stream. Those skilled in the art will be readily able to devise other embodiments of such couplings.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A flow meter, comprising:
a first coupling configured to couple to an inlet from a flow stream at one end and to one side of a meter element at another end;
a second coupling configured to couple at one end to an outlet to the flow stream and to the other side of the meter element at another end thereof;
a meter element disposed between the first and second couplings, the meter element configured to generate a pressure drop in flowing fluid related to a flow rate of the fluid through the meter element, the meter element having metal to metal sealing surfaces for engagement with corresponding sealing surfaces on the respective ends of the first and second couplings.

2. The flow meter of claim 1 wherein the meter element comprises an orifice.

3. The flow meter of claim 1 wherein the meter element comprises a wedge.

4. The flow meter of claim 1 wherein the meter element comprises a Pitot tube.

5. The flow meter of claim 1 wherein the first and second couplings each comprise a port in fluid communication with an interior thereof.

6. The flow meter of claim 1 wherein an axial dimension of the meter element is selected to enable insertion between the first and second couplings of one of a plurality of different type meter elements each having a same axial dimension.
